(19) United States
(12) Patent Application Publication
(10) Pub. No.: US 2014/0197659 A1
(43) Pub. Date: Jul. 17, 2014

(54) SLIDING TARPAULIN TENSIONING AND LOCKING SYSTEM

(71) Applicant: Petelka Investments Inc., Burlington (CA)

(72) Inventors: Brian W. Petelka, Burlington (CA); Rob Henry, Burlington (CA)

(73) Assignee: Petelka Investments Inc., Burlington (CA)

(21) Appl. No.: 14/154,935

(22) Filed: Jan. 14, 2014

Related U.S. Application Data
(60) Provisional application No. 61/752,178, filed on Jan. 14, 2013.

(51) Int. Cl. B60P 7/04

(52) U.S. Cl. CPC B60P 7/04
USPC 296/100.15

(57) ABSTRACT

An improved tensioning and locking apparatus for tensioning and locking a sliding tarpaulin that selectively covers and uncovers a trailer, such as a flat bed trailer or an enclosed trailer with an opening in a side thereof. Rotational motion about an axis perpendicular (or substantially perpendicular) to the length of the trailer can be used to operate the apparatus to either increase or decrease tension in the tarpaulin covering the trailer. Such rotational motion can be provided from outside the covered trailer, which is advantageous for operators of said trailers.

### CLAIM OF PRIORITY

This application claims the benefit of priority under 35 U.S.C. §119(e) of U.S. Provisional Patent Application Ser. No. 61/752,178, filed on Jan. 14, 2013, which prior application is incorporated by reference herein in its entirety.

### FIELD OF INVENTION

The invention relates generally to tarpaulin systems for covering the beds of vehicle trailers. In particular, the invention relates to devices and systems for tensioning a tarpaulin that is deployed to cover the bed of a vehicle trailer, and locking said tarpaulin in place.

### BACKGROUND OF THE INVENTION

Trucks having trailers with flat beds, which are well known in the transportation industry, are commonly used for shipping goods, either locally, regionally or internationally. In order to protect goods loaded on the flat bed from exposure to the elements, vandalism or theft, the goods are typically covered with tarpaulins, or tarps.

Many types of systems exist that facilitate the covering and uncovering of a flat bed trailer with a tarp. By way of example, one type of system includes a plurality of arch-shaped frames, referred to as “cars”, having wheels mounted at each end of the arch. These wheels are received by, and can slide in “C”-shaped tracks mounted on the sides of a flat bed, such that the arch of each of the cars extends over the surface of the flat bed. The cars are arranged at spaced intervals along the entire length of the flat bed, and a tarp extends over and is affixed to the arches of the cars to cover the flat bed.

The flat bed can be uncovered by sliding the car at the back of the flat bed towards the front, causing it and the other cars to gather at the front of the flat bed and the tarp to retract, exposing the flat bed. The flat bed can be re-covered by sliding the rear car toward the back of the flat bed again, causing the remaining cars to return to their original spaced apart positions and the tarp to unfurl, covering the flat bed. The flat bed also can be uncovered by sliding the front car toward the rear of the flat bed, and recovered by sliding the front car back to the front.

To prevent the tarp from opening while the truck is moving, to decrease the aerodynamic forces acting against the truck, and to increase the fuel efficiency of the truck, it is desirable that the tarp be locked in the closed position (that is, the position in which the tarp covers the flat bed), and that the tarp be taut while in the closed position. For flat beds having tarp systems as described above, the locking and tensioning of the tarp can be achieved by sliding the rear car as far to the rear of the flat bed as possible, and locking the rear car in place against sliding movement toward the front of the flat bed.

Canadian patent application No. 2,595,513 (the “'513 Application”) discloses a mechanism for pulling the rear car as far to the rear of the flat bed as possible, and locking it in place. The '513 Application discloses a shaft assembly mounted to an interior surface of the rear car. The shaft assembly has a downward-facing slot formed therein and a second slot extending perpendicularly from one end of the downward-facing slot. Both of these slots provide access to a space within the shaft assembly. A threaded thrust shaft is provided within said space, and a threaded thrust nut is mounted on the thrust shaft within the thrust shaft space. The thrust nut has an arm extending radially outward through either the downward-facing slot or the second slot, depending on the position of the thrust nut along the thrust shaft, and out of the shaft assembly. The thrust shaft extends out a rear end of the shaft assembly, where a rotation nut is mounted on the thrust shaft. The mechanism can be operated by rotating the rotation nut, thus rotating the thrust shaft about its elongate axis.

While useful, the mechanism of the '513 Application does not allow for its operation by one located outside the flat bed. Rather, to operate the mechanism one must be in the covered flat bed to turn the rotation nut. This can be problematic when the flat bed has been backed up to a loading dock, which may block access to the interior of the flat bed. This also can be problematic when the interior space of the flat bed is full of cargo, and there is no space for access to the rotation nut.

As well, the operation of the mechanism disclosed in the '513 Application requires the rotation of the rotation nut about an axis parallel to the length of the flat bed. Since the mechanism must be mounted on the rear car, which is effectively the side wall of the covered flat bed, and near the deck of the flat bed, gaining access to the rotation nut for rotation about this axis can be problematic.

### SUMMARY OF THE INVENTION

The invention provides an improved tensioning and locking apparatus for tensioning and locking a sliding tarpaulin that selectively covers and uncovers a trailer, such as a flat bed trailer or an enclosed trailer with an opening in a side thereof. Rotational motion about an axis perpendicular (or substantially perpendicular) to the length of the trailer can be used to operate the apparatus to either increase or decrease tension in the tarpaulin covering the trailer. Such rotational motion can be provided from outside the covered trailer, which is advantageous for operators of said trailers.

In one embodiment, the invention comprises a sliding tarpaulin tensioning and locking apparatus, comprising: an elongate rod housing for mounting on a sliding tarpaulin system, the rod housing comprising an elongate slot formed therein and a transverse slot formed therein at one end of the elongate slot, the elongate slot and transverse slot in communication with each other and with a rod space formed within the rod housing; a threaded rod provided in the rod space; a threaded tensioning nut circumscribing the rod within the rod space, the tensioning nut having an arm extending therefrom through one of the elongate slot and the transverse slot to an exterior of the rod assembly; and rotational motion transmission means having an input for receiving rotational motion about an axis perpendicular to the rod, and an output in rotational engagement with the rod; wherein rotation of the input about an axis perpendicular to the rod causes the rod to rotate about its elongate axis; and wherein rotation of the rod about its elongate axis causes the tensioning nut to rotate about said axis, causing the tensioning nut arm to move along one of the elongate slot and the transverse slot.

In one embodiment, the invention comprises a flat bed trailer comprising a flat bed, a plurality of arch-shaped members slidably mounted to the flat bed such that the arch-shaped members may slide along the length of the flat bed, a tarpaulin extending over each of the plurality of arch-shaped members, a sliding tarpaulin tensioning and locking apparatus as described in paragraph [0010] mounted on one of the plurality of arch-shaped members, and a stopping flange mounted to the flat bed for engaging the tensioning nut arm of the sliding tarpaulin tensioning and locking apparatus and preventing the arch-shaped member to which the sliding tarpaulin tensioning and locking apparatus is mounted from sliding past the stopping flange.

In one embodiment, the invention comprises an enclosed trailer having a selectively openable side, comprising at least one opening in at least one side of the trailer, a plurality of elongate support members extending from a first end of the at least one opening to a second end of the at least one opening, the plurality of elongate support members being slidably attached to the trailer such that each of the elongate support members can slide along the length of the opening, a tarpaulin extending over each of the plurality of elongate support members, a sliding tarpaulin tensioning and locking apparatus as described in paragraph [0010] mounted on one of the plurality of elongate support members, and a stopping flange mounted to the enclosed trailer for engaging the tensioning nut arm of the sliding tarpaulin tensioning and locking apparatus and preventing the elongate support member to which the sliding tarpaulin tensioning and locking apparatus is mounted from sliding past the stopping flange.

### DESCRIPTION OF THE DRAWINGS

FIG. 1 is a perspective view of a flat bed trailer having a tarp covering system with which the present invention can be used.

FIGS. 1A, 1B, 2 and 3 are perspective views of a component of the tarp covering system of FIG. 1, with the tensioning and locking apparatus of the present invention mounted thereon.

FIG. 4 is a perspective view of the tarp tensioning and locking apparatus of the present invention, mounted on the tarp covering system of FIG. 1.

FIG. 5 is a perspective view of the tarp tensioning and locking apparatus of FIG. 4.

FIG. 6 is an exploded view of the tarp tensioning and locking apparatus of FIG. 4.

FIGS. 7 and 8 illustrate an alternative embodiment of the tarp tensioning and locking apparatus of FIG. 4.

### DETAILED DESCRIPTION OF EMBODIMENTS OF THE INVENTION

Example embodiments of the improved tarp tensioning and locking apparatus of the present invention will now be described with reference to the attached figures.

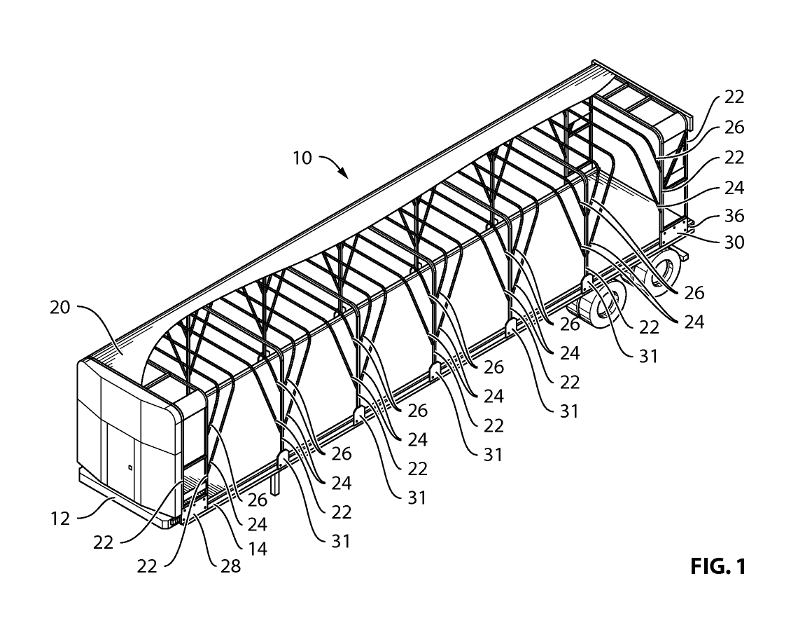

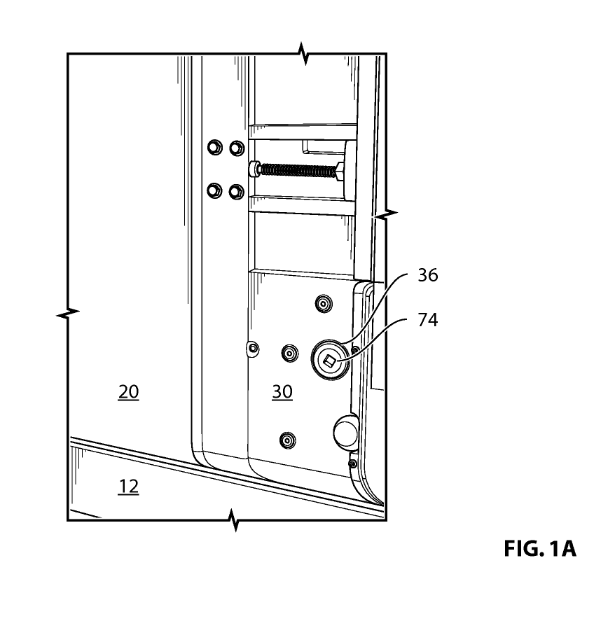

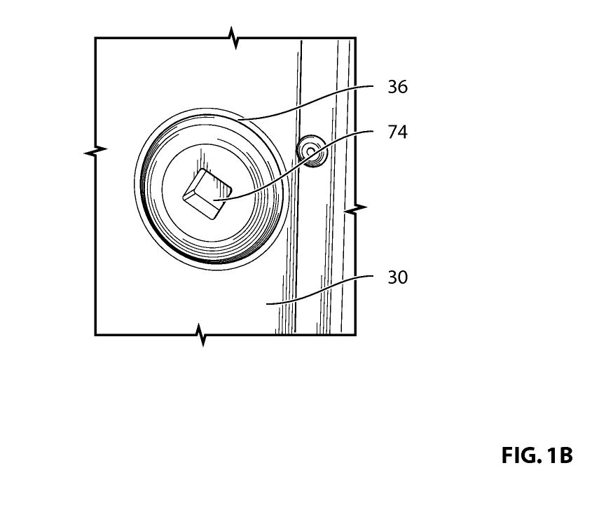

FIG. 1 illustrates a flat bed trailer having one example of a tarp covering system with which the tarp tensioning and locking apparatus of the present invention can be used. The trailer 10 comprises a rectangular flat bed 12 having elongate left and right sides and transverse front and rear sides. The flat bed 12 is mounted on wheels at its rear end. The flat bed 12 has “C”-shaped tracks 14 mounted on its left and right sides.

A plurality of arch-shaped assemblies are arranged in a spaced-apart configuration along the length of the flat bed 12. Each of the assemblies comprise at least one arch 22 and an end assembly known as a “car” 28, 30, 31 at each end of the arch 22. The assemblies at the front and rear of the flat bed 12 comprise two arches 22 connected at their ends to a front car 28 and rear car 30, respectively. The other assemblies each comprise one arch 22 connected at each end to a middle car 31.

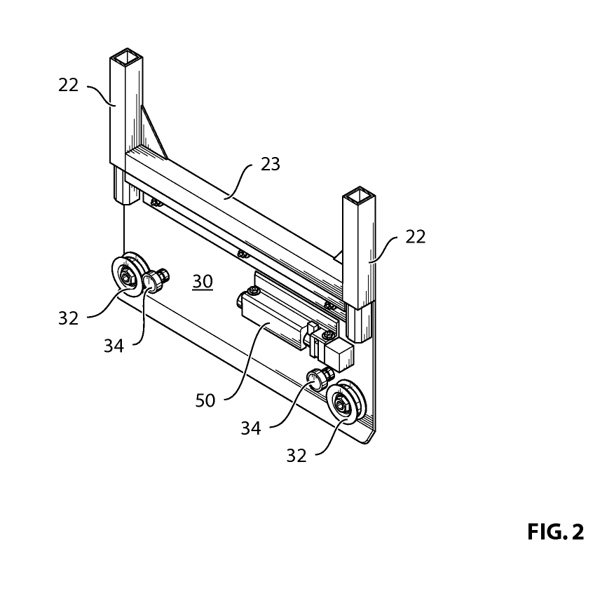

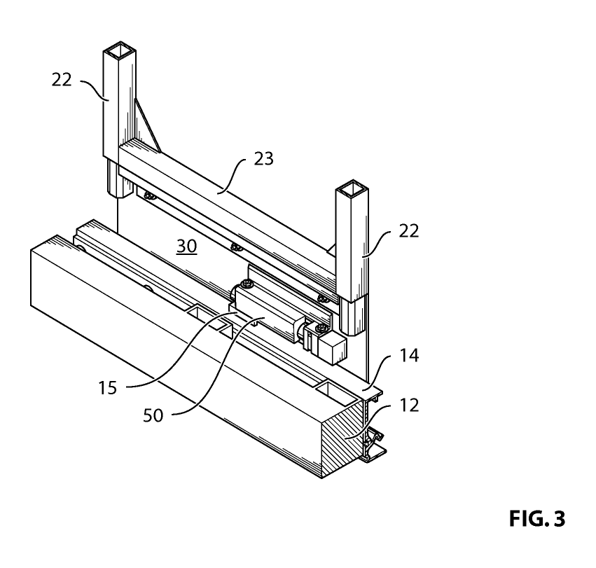

The rear car 30 is shown in isolation in FIG. 2, and is shown mounted on the flat bed in FIG. 3. The rear car 30 has wheels 32 and 34 to facilitate mounting the rear car 30 on the flat bed 12 such that it can slidably move along the length of the flat bed 30. The wheels 32 and 34 are received in the “C”-shaped tracks 14 as shown in FIG. 3, which retains the rear car 30 on the side of the flat bed 12 and allows it to slide up and down the length of the flat bed 12. The front car 28 and middle car 31 are mounted to the flat bed 12 in substantially the same manner.

One of the rear cars 30 also has one embodiment 50 of the tensioning and locking mechanism of the present invention mounted thereto. The tensioning and locking mechanism 50 is mounted on an interior surface of the rear car 30 as shown in FIGS. 2 and 3. An access port 36, shown in FIG. 1 is formed in the rear car 30, allowing access to an adapter 74, shown in FIGS. 1A and 1B. As will be explained in greater detail below, the tensioning and locking mechanism 50 can be operated to pull a tarp covering the trailer 10 taught and lock the tarp in place by rotating the adapter 74. As such, the adapter 74 is provided for engaging a handle of any suitable means to allow an operator to rotate the adapter 74. By way of example, the adapter 74 could be adapted to connect with a standard socket wrench (either manually or electrically powered) to allow for easy rotation of the adapter 74.

Referring back to FIG. 1, each of the arches 22 has double uplifters 24 and quad uplifters 26 pivotally mounted thereto. These uplifters 24 and 26 are arch-shaped members that hang off the arches 22 at an angle such that top portions of the uplifters 24 and 26 and the arches 22 rest in substantially the same plane. A tarp 20 extends over each of the arches 22 and uplifters 24 and 26, covering the flat bed 12. The tarp 20 is removably affixed to each of the arches 22 and uplifters 24 and 26.

The flat bed 12 can be uncovered by sliding the rear car 30 toward the front of the flat bed 12, or alternatively by sliding the front car 28 toward the rear of the flat bed 12. Such movement causes the tarp 20 to bunch up, which causes the uplifters 24 and 26 to pivot upwards toward the arches 20. This pivotal movement lifts sections of the tarp 20 upward and out of the space between the arches 22, allowing the arches 22 to move closer together as the rear car 30 moves backward (or the front car 28 moves forward) pushing the middle cars along with it.

It can easily be seen that the flat bed 12 can be recovered by sliding the rear car 30 back toward the rear of the flat bed 12 (or by sliding the front car 28 back toward the front of the flat bed 12). To pull the tarp 20 taut, the rear car 30 can be pulled backward along the tracks 14 as far as possible. To lock the tarp 20 in such a closed, taut position, the rear car 30 can be restrained from moving forward along the tracks 14 until it is desired that the flat bed 12 be uncovered.

Such tensioning of the tarp 20 and locking of the rear car 30 can be accomplished with one embodiment 50 of the tensioning and locking mechanism of the present invention, which is shown mounted to the rear car 30 in FIGS. 2, 3 and 4. The tensioning and locking mechanism 50 can be mounted to the rear car 30 in any suitable manner, such as by threaded bolts extending through mounting holes formed in the mechanism 50 and into receiving holes formed in the rear car 30.

In the manner that will be described below, the tensioning and locking mechanism 50 engages a system stopper 15, comprising an upwardly extending flange for engaging locking mechanism 50 and preventing the rear car 30 from moving forward past the stopper 15. The system stopper 15 is mounted on the upper surface of the track 14 adjacent to the locking mechanism 50. When the tensioning and locking mechanism 50 engages the system stopper 15, the tensioning and locking mechanism 50 exerts force against the system stopper 15 in a forward direction. Since the system stopper 15 is mounted to the track 14 and cannot move, the exerted force causes the rear car 30 to slide further backward along the tracks 14, pulling the tarp 20 taut. As well, the engagement of the tensioning and locking mechanism 50 with the system stopper 15 prevents the rear car 30 from sliding forward along the tracks 14, thus locking the rear car 30 and the tarp 20 in a closed position.

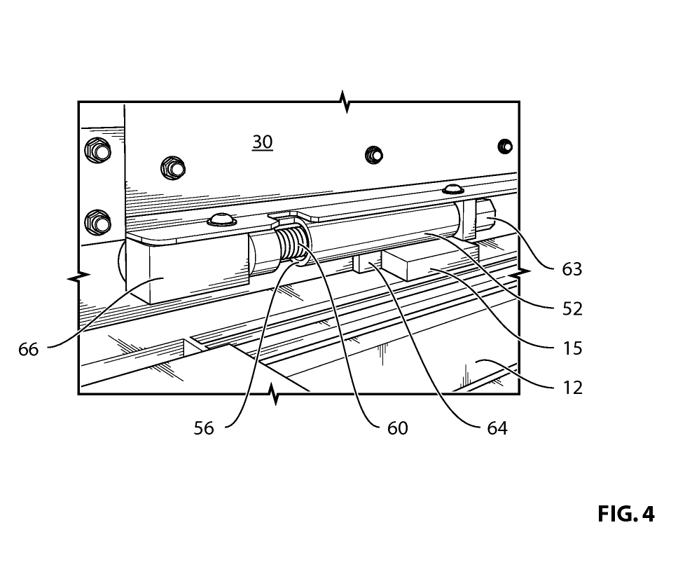

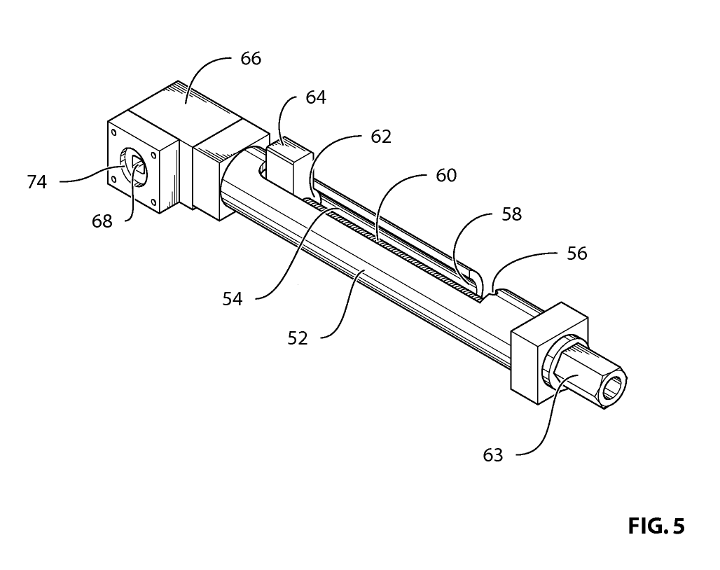

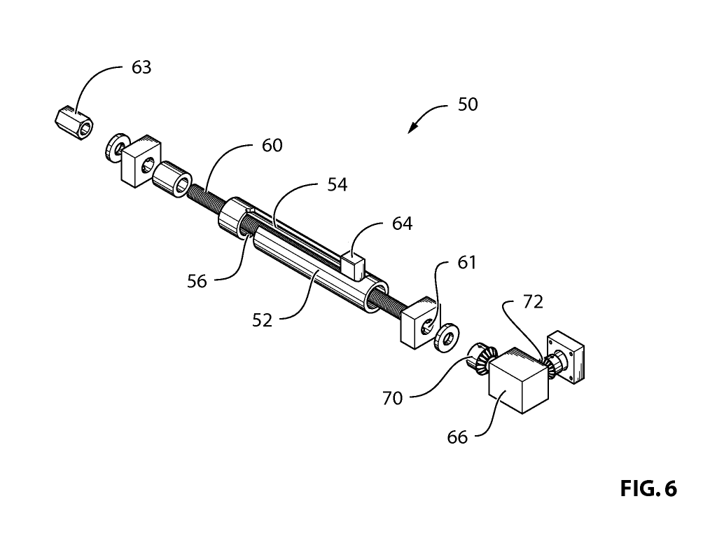

FIG. 4 illustrates the tensioning and locking mechanism 50 mounted on the inside surface of a rear car 30. FIG. 5 illustrates the tensioning and locking mechanism 50 in isolation and in an assembled condition. FIG. 6 illustrates the tensioning and locking mechanism 50 in isolation and in a disassembled condition. The mechanism 50 comprises an elongate housing 52. The housing (and all other components of the mechanism 50) can be made from stainless steel or any other similarly strong and durable material. The housing 52 is hollow, thus forming an interior space 58, which will be referred to as a rod space, therein. As well, two slots, an elongate slot 54 and a transverse slot 56 are formed in the housing 52. The elongate slot runs along a substantial portion of the length of the housing 52, and connects with the transverse slot 56 at one end thereof. The transverse slot 56 is a “C”-shaped slot extending around the housing 52. Both the elongate slot 54 and the transverse slot 56 extend entirely through the wall of the housing 52, thus opening into the rod space 58.

A threaded rod 60 is provided within the rod space 58. It is inserted into the rod space 58 through the hole 61 formed in the end of the housing 52 adjacent to the transverse slot 56. A threaded tensioning nut 62 circumscribes the rod 60 within the rod space 58. The tensioning nut 62 has a tensioning nut arm 64 extending radially therefrom. When the tensioning nut 62 is within the rod space 58, the tensioning nut arm 64 extends through either the elongate slot 54 or the transverse slot 56 to the space external to the housing 52. When the tensioning nut arm 64 extends downwardly through the elongate slot 54, the tensioning nut arm 64 extends sufficiently far downward so that it engages the system stopper 15 when adjacent thereto.

The tensioning nut 62 is provided on the rod 60 by inserting the tensioning nut 62 into the rod space 58 through the transverse slot 56, such that the tensioning nut arm 64 extends outwardly from the rod space 58 into the transverse slot 56. The rod 60 is then inserted into the hole 61 as described above. When the end of the rod 60 reaches the tensioning nut 62, the threads of the rod 60 and tensioning nut 62 engage one another. The rod 60 is then rotated clockwise to drive the rod 60 further into the rod space 58 while the tensioning nut 62 remains in its position at the transverse slot 56.

When fully inserted, the end of the rod 60 extends out of the opposite end of the housing 52 through a hole (not shown) opposite the hole 61. A threaded nut 63 is placed on the end of the rod 60 to prevent the rod 60 from sliding out of the housing 52.

The end of the rod 60 proximate the hole 61 comprises a gear 70. The gear 70 comprises teeth having angled surfaces that are adapted to matingly engage the teeth of a similar gear arranged at a 90-degree angle to the gear 70. In other words, the gear 70 is adapted to receive rotational motion about an axis perpendicular (or substantially perpendicular) to the rod 60 and rotate the rod 60 about its axis.

When the rod 60 is fully inserted into the housing 52, the gear 70 protrudes from the hole 61 and is covered by a housing 66. The housing 66 has four side surfaces and an end surface, and has an opening 68 formed in one of the side surfaces for allowing access to the gear 70 from outside the housing 66 along an axis perpendicular to the rod 60. Once the rod 60 is fully inserted into the housing 52, the housing 66 is attached to the end of the housing 52 (by any suitable means), covering the gear 70.

In the embodiment depicted in FIGS. 1 to 6, a rotation gear 72 is provided within the housing 66 and is kept in engagement with the gear 70. The rotation gear 72 is of a similar configuration to that of gear 70, so that the teeth of rotation gear 72 can engage the teeth of gear 70 at an angle of approximately 90 degrees. The rotation gear is connected to the adapter 74, which is accessible from the opening 68. The housing 66, rotation gear 72 and adapter 74 are all mounted to the mechanism 50 such that the opening 68 is aligned with the access port 36, allowing the mechanism 50 to be operated (in the manner described below), by rotating the adapter 74 as described above, from a position outside of the trailer 10. It will be understood, however, that alternative embodiments are possible, wherein the housing 66, rotation gear 72 and adapter 74 are mounted such that the opening 68 is oriented in a different direction, allowing for operation of the mechanism 50 from different positions, such as within the trailer 10, if desired.

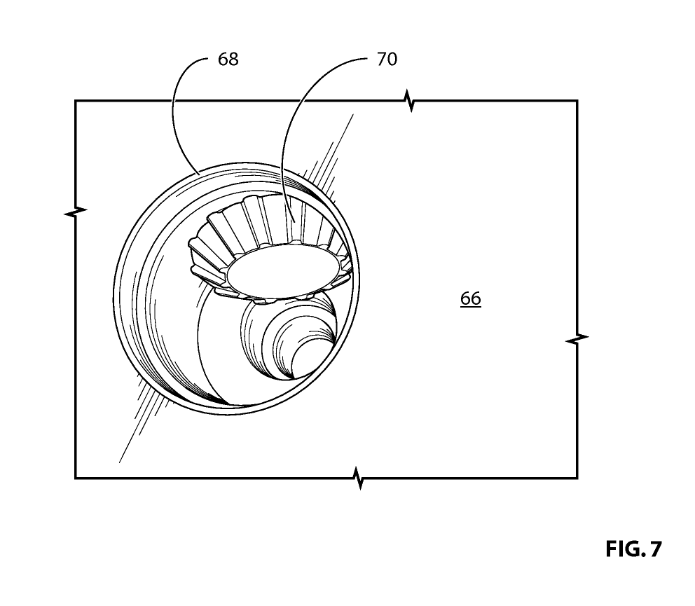

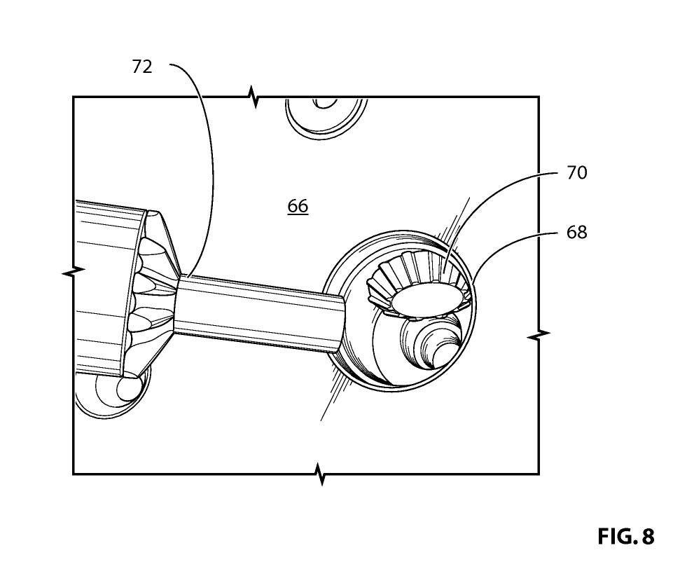

In alternative embodiments depicted in FIGS. 7 and 8, the adapter 74 is omitted and the rotation gear 72 is not provided within the housing 66. In such embodiments, the rotation gear 72 is instead provided by the operator and is inserted in the opening 68 (by way of the access port 36 in embodiments wherein the access port 36 and opening 68 are aligned) and engages the gear 70. To operate the mechanism 50 in such embodiments, the operator rotates the rotation gear 72 in any suitable manner.

To operate the embodiments shown in FIGS. 1 to 6 to (a) cover the flat bed 12 with the tarp 20, (b) pull the tarp 20 taut and (c) lock the tarp 20 in place, the rear car 30 is pulled toward the rear of the flat bed 12. When the tarp 20 is in the open, uncovered position (i.e., before the rear car 30 is pulled rearward), the tensioning nut arm 64 extends upwardly through the transverse slot 56 and away from the flat bed 12. Therefore, the mechanism 50 and rear car 30 can move freely past the system stopper 15 when the rear car 30 is pulled rearward, because the tensioning nut arm 64 does not engage the system stopper 15.

Once the tensioning nut 62 has been pulled to the rear of the system stopper 15, the mechanism 50 can be operated by connecting a socket wrench (or any other suitable handle) to the adapter 74 via access port 36 and opening 68, and rotating the adapter. Rotation of the adapter 74 causes rotation of the both the rotation gear 72, the gear 70 within the housing 66, and the rod 60. In particular, rotational movement of rotation gear 72 about an axis perpendicular to the rod 60 will cause rotation of gear 70 and rod 60 about the axis of the rod 60.

By rotating adapter 74 in a counter clockwise direction, rod 60 is rotated counter clockwise, causing tensioning nut arm 64 to rotate 180 degrees through the transverse slot 56 from an upwardly extending position to a downwardly extending position. Once in this position, the tensioning nut arm 64 is prevented from further rotation by the edge of the transverse slot 56. Further rotation of the rod 60 therefore causes the tensioning nut 62 to move forward along the rod 60, because of the threaded engagement of the threads of the rod 60 and tensioning nut 62. Such movement of the tensioning nut 62 causes the tensioning nut arm 64 to move forward through the elongate slot 54.

Eventually, the tensioning nut arm 64 engages the system stopper 15, which blocks the tensioning nut arm 64 and tensioning nut 62 from further forward movement. Further rotation of the adapter 74 therefore causes the rod 60, the nut 63, the housing 52 and the rear car 30 all to move rearward, pulling the tarp 20 taut. The user can continue to rotate the adapter 74 until the desired tension in the tarp is reached. When rotation of the adapter 74 stops, the rear car 30 and tarp 20 will be locked in place by the engagement of the tensioning nut arm 64 with the system stopper 15.

To open the flat bed 12, the process is reversed. Rotation of the adapter 74 in the clockwise direction causes clockwise rotation of the rod 60, which causes the tensioning nut 62 and tensioning nut arm 64 to move rearward through the rod space 58 and elongate slot 54, respectively. Once the tensioning nut arm 64 reaches the rear of the elongate slot 54, it enters into the transverse slot 56 and is able to rotate 180 degrees through the transverse slot 56 to an upwardly extending position, whereby it cannot engage the system stopper 15. The rear car 30 is then free to slide forward of the system stopper 15.

By using a socket wrench or any other suitable handle to engage and rotate the adapter 74, the mechanism 50 can be operated from positions where it is more convenient to both access the mechanism 50 and provide the torque necessary to operate the mechanism 50. In particular, by providing access to the adapter 74 from the outside of the flat bed 12 by aligning the opening 68 with the access port 36, users can easily gain access to the mechanism 50 and provide the torque necessary to operate it without having to gain access to the interior of the flat bed 12 (which may be difficult, or even impossible, depending on where the flat bed 12 is parked and the load contained therein.)

Exterior access to the adapter 74 also allows for operation of the mechanism 50 when the flat bed 12 is parked at a loading dock, and the interior is not accessible. Without such operability, the flat bed 12 would have to be opened before it is positioned at the loading dock, requiring the driver to manoeuvre the flat bed 12 to the loading dock while the flat bed 12 is open, impeding visibility. With the mechanism 50 of the present invention, visibility while manoeuvring the flat bed 12 to a loading dock can be greatly improved.

It will be apparent to those having ordinary skill in the art that certain adaptations and modifications of the described embodiments can be made, consistent with and without departing from the present invention. Unless otherwise indicated, the embodiments described in the invention shall be understood to be non-exclusive of each other such that any embodiment can include different features of other embodiments. Therefore, the above discussed embodiments are considered to be illustrative and not restrictive. Other embodiments consistent with the present invention will become apparent from consideration of the specification and the practice of the present invention taught and suggested herein. By way of example, it will be apparent to those of skill in the art that any known manner of translating rotational motion from one plane to another can be used in place of the gear 70 and rotation gear 72 to allow for easy access to and operation of the mechanism 50. It also will be apparent to those of skill in the art that the present invention can be used with any form of sliding tarpaulin system comprising a tarpaulin affixed to a plurality of cars that slide along a track. For example, the present invention can be used with a curtain-style sliding tarpaulin system installed on a single surface of a covered trailer, in addition to systems that cover flatbed trailers such as the one described herein. Accordingly, the specification and the embodiments disclosed therein are to be considered exemplary only, with the true scope of the present invention being identified in the following claims.

1. A sliding tarpaulin tensioning and locking apparatus, comprising:
an elongate rod housing for mounting on a sliding tarpaulin system, the rod housing comprising an elongate slot formed therein and a transverse slot formed therein at one end of the elongate slot, the elongate slot and the transverse slot in communication with each other and with a rod space formed within the rod housing;
a threaded rod provided in the rod space;
a threaded tensioning nut circumscribing the rod within the rod space, the tensioning nut having an arm extending therefrom through one of the elongate slot and the transverse slot to an exterior of the rod housing; and
rotational motion transmission means having an input for receiving rotational motion about an axis perpendicular to the rod, and an output in rotational engagement with the rod;
wherein rotation of the input about an axis perpendicular to the rod causes the rod to rotate about its elongate axis;
and wherein rotation of the rod about its elongate axis causes the tensioning nut to rotate about said axis, causing the tensioning nut arm to move along one of the elongate slot and the transverse slot.

2. The sliding tarpaulin tensioning and locking apparatus of claim 1, wherein the input of the rotational motion transmission means comprises an input gear, and the output of the rotational motion transmission means comprises an output gear, said input and output gear being substantially perpendicular to and in rotational engagement with one another.

3. The sliding tarpaulin tensioning and locking apparatus of claim 2, wherein the rotational motion transmission means further comprises an adapter in rotational engagement with the input gear, the adapter being adapted to engage with a tool for rotating the adapter.

4. The sliding tarpaulin tensioning and locking apparatus of claim 3, wherein the adapter comprises a socket for matingly engaging with a socket wrench.

5. The sliding tarpaulin tensioning and locking apparatus of claim 1, wherein the rotational motion transmission means comprises a gear in rotational engagement with the threaded rod, the gear being adapted to receive rotational motion about an axis substantially perpendicular to the threaded rod and rotate in response to rotation of the threaded rod.

6. A flat bed trailer comprising a flat bed, a plurality of arch-shaped members slidably mounted to the flat bed such that the arch-shaped members may slide along the length of the flat bed, a tarpaulin extending over each of the plurality of arch-shaped members, a sliding tarpaulin tensioning and locking apparatus of claim 1 mounted on one of the plurality of arch-shaped members, and a stopping flange mounted to the flat bed for engaging the tensioning nut arm of the sliding tarpaulin tensioning and locking apparatus and preventing the arch-shaped member to which the sliding tarpaulin tensioning and locking apparatus is mounted from sliding past the stopping flange.

7. The flat bed trailer of claim 6, wherein the input of the rotational motion transmission means of the sliding tarpaulin tensioning and locking apparatus comprises an input gear, and the output of the rotational motion transmission means of the sliding tarpaulin tensioning and locking apparatus comprises an output gear, said input and output gear being substantially perpendicular to and in rotational engagement with one another.

8. The flat bed trailer of claim 7, wherein the rotational motion transmission means of the sliding tarpaulin tensioning and locking apparatus further comprises an adapter in rotational engagement with the input gear, the adapter being adapted to engage with a tool for rotating the adapter.

9. The flat bed trailer of claim 8, wherein the adapter comprises a socket for matingly engaging with a socket wrench.

10. The flat bed trailer of claim 6, wherein the rotational motion transmission means of the sliding tarpaulin tensioning and locking apparatus comprises a gear in rotational engagement with the threaded rod, the gear being adapted to receive rotational motion about an axis substantially perpendicular to the threaded rod and rotate in response to rotation of the threaded rod.

11. An enclosed trailer having a selectively openable side, comprising at least one opening in at least one side of the trailer, a plurality of elongate support members extending from a first end of the at least one opening to a second end of the at least one opening, the plurality of elongate support members being slidably attached to the trailer such that each of the elongate support members can slide along the length of the opening, a tarpaulin extending over each of the plurality of elongate support members, a sliding tarpaulin tensioning and locking apparatus of claim 1 mounted on one of the plurality of elongate support members, and a stopping flange mounted to the enclosed trailer for engaging the tensioning nut arm of the sliding tarpaulin tensioning and locking apparatus and preventing the elongate support member to which the sliding tarpaulin tensioning and locking apparatus is mounted from sliding past the stopping flange.

12. The enclosed trailer of claim 11, wherein the input of the rotational motion transmission means of the sliding tarpaulin tensioning and locking apparatus comprises an input gear, and the output of the rotational motion transmission means of the sliding tarpaulin tensioning and locking apparatus comprises an output gear, said input and output gear being substantially perpendicular to and in rotational engagement with one another.

13. The enclosed trailer of claim 12, wherein the rotational motion transmission means of the sliding tarpaulin tensioning and locking apparatus further comprises an adapter in rotational engagement with the input gear, the adapter being adapted to engage with a tool for rotating the adapter.

14. The enclosed trailer of claim 13, wherein the adapter comprises a socket for matingly engaging with a socket wrench.

15. The enclosed trailer of claim 11, wherein the rotational motion transmission means of the sliding tarpaulin tensioning and locking apparatus comprises a gear in rotational engagement with the threaded rod, the gear being adapted to receive rotational motion about an axis substantially perpendicular to the threaded rod and rotate in response to rotation of the threaded rod.
